(19) United States
(12) Patent Application Publication
(10) Pub. No.: US 2002/0102962 A1
(43) Pub. Date: Aug. 1, 2002

(54) Apparatus and method for prepaid charging of coexistent wireless circuit-switched calls and packet- switched calls

(76) Inventors: James M. Grinn, Plano, IL (US); Somasundaram Velayutham, Aurora, IL (US); Joe Ping Zhou, Naperville, IL (US)

Correspondence Address: Docket Administrator (Room 3C-512), Lucent Technologies, Inc., 600 Mountain Avenue, P.O. Box 636, Murray Hill, NJ, 07974-0636, US

(21) Appl. No.: 09/810,768

(22) Filed: Mar. 16, 2001

Related U.S. Application Data
(63) Continuation-in-part of application No. 09/773,039, filed on Jan. 31, 2001.

(51) Int. Cl. H04M 11/00

(52) U.S. Cl. 455/406; 455/408

(57) ABSTRACT

The present invention enables a wireless communications system to support prepaid charging for a packet-switched call and a circuit-switched call that are associated with a subscriber and that are coexistent. The present invention utilizes an integrated accounting processor that fetches an amount remaining in the subscriber's prepaid account and determines a balance that the subscriber may consume. An integrated prepaid node (IPPN) that is logically associated with an integrated wireless packet services node (IWPSN) monitors the usage associated with the packet-switched call and the circuit-switched call. When the packet-switched call ends, the IPPN reports the usage consumed during the packet-switched call and the circuit-switched call to the integrated accounting processor. The integrated accounting processor adjusts the subscriber's prepaid account in accordance with the usage. If the usage exceeds the balance during the calls, the IWPSN initiates the termination of the calls, and the IPPN notifies the integrated accounting processor.

### CROSS-REFERENCE TO RELATED APPLICATIONS

This application is related to the application of Charles A. Gerlach, James M. Grinn, Subhasis Laha, Somasundaram Velayutham, and Joe P. Zhou entitled “Apparatus And Method For Prepaid Charging Of Wireless Packet Data Services” which application is assigned to the assignee of the present application, filed on Jan. 31, 2001 and assigned Ser. No. 09/773039.

### FIELD OF THE INVENTION

The present invention provides apparatus and methods for prepaid charging of wireless packet data services.

### BACKGROUND OF THE INVENTION

Wireless communications is an integral part of many people's business and personal lives. There is therefore a diversity of wireless services to satisfy these sometimes very diverse requirements ranging from voice to data services. There is also a spectrum of billing systems that satisfy the various needs of different wireless subscribers. For example, a wireless subscriber can pay a monthly charge for a designated number of minutes of use. If the wireless subscriber does not use all the designated minutes of use, the wireless subscriber still pays the same monthly charge. On the other hand, if the wireless subscriber uses more than the designated number of minutes, the wireless subscriber pays an additional charge. It therefore behooves the wireless subscriber to estimate the actual number of minutes of use to be as close to the actual monthly usage as possible when subscribing to a plan of this nature. Even if the wireless subscriber can accurately gauge his or her usage, the actual usage can vary from one month to another. The service provider processes billing information about the wireless subscriber's calls at a time subsequent to the call activity. This billing plan is referred as a “post-call billing plan.”

“Prepaid billing” is an alternative billing plan to the “post-call billing plan.” With “prepaid billing”, the wireless subscriber typically pays in advance for a given number of minutes of use. The wireless subscriber's prepaid account is debited for the actual usage. The service provider can utilize one of several methods for determining usage. First, the service provider can process call detail records (CDR) after call activity, as with the post-call billing plan. A second method is to monitor each call and to deduct the call's time duration from the purchased time. The second method is usually preferred over the first method. With the first method, the wireless subscriber can exceed usage as specified by the purchased time because CDR's are processed after call activity. If the wireless subscriber does not generate any usage for a given month, the prepaid account is not charged for the month. Thus, the wireless subscriber pays for the actual usage, although the rate per minute is typically higher for the “prepaid billing plan” in comparison with the “post-call billing plan.” Many wireless subscribers have found that the “prepaid billing plan” to be very appealing, increasing revenues for wireless service providers. In fact, some wireless service providers have a customer base in which about fifty percent of the wireless subscribers choose the “prepaid billing plan.” Moreover, service providers enjoy the benefit of minimizing billing efforts by collecting payment in advance. Both of these billing systems, however, are based on assumptions concerning how calls are made (“call model”) that trace their roots to the earliest telephone systems. These call models may or may not have relevance going forward.

Wireless communications systems (as typified by second generation wireless systems called “2G” systems) implement wireless services with a circuit-switched call model. With the circuit-switched call model, wireless communications between the wireless device (e.g. a mobile telephone, a fixed wireless telephone, a wireless palm pilot, a wireless data terminal, or a computer having wireless access) and the telephone network is dedicated on a physical path for a given duration of time. However, wireless communications systems are moving to third generation (“3G”) wireless systems in which call processing is able to support a packet switched call model as well as a circuit-switched call model. With a packet-switched call model, information may be transferred at a variable rate (possibly having a large variance) with the transmission of packets rather than at a constant rate. Thus, a wireless communications system may need to support both circuit-switched services and packet-switched services.

Wireless communications systems are evolving to provide coexisting packet-switched calls and circuit-switched calls for a subscriber. Numerous scenarios illustrate the need for coexistence. As an example, a retailer (a subscriber) can be communicating with a customer utilizing a voice (circuit-switched) call and simultaneously verifying a credit card transaction utilizing a packet switched call to a credit card verification center. In this example, the subscriber communicates to two different destinations, combining a circuit-switched call and a packet-switched call in order to provide an integrated service for the subscriber.

In a second example, a subscriber, who is traveling and is attempting to locate a restaurant, calls the subscriber's automobile travelers club. While talking to an agent (utilizing a circuit-switched call), the agent generates a map (utilizing a packet-switched call) in order to provide directions as displayed on the subscriber's terminal. In both cases, however, the prior art separates prepaid charging for the circuit-switched call from prepaid charging for the circuit-switched call and thus may require two processing entities for the charging function in such cases.

FIG. 1 illustrates an architecture of wireless communications system 100 that supports prepaid charging (billing) for circuit-switched calls according to prior art. Wireless device 101 is connected to public switching telephone network (PSTN) 105 through radio link 110, radio network 102, interface 111, mobile switching center (MSC) 103, and interface 112. Radio network 102 comprises at least one base station and at least one radio controller in order to provide communications for wireless device 101 while wireless device 101 is within a service coverage area of wireless communications system 100. MSC 103 notifies Prepaid Charging (PPC) processor 104 about any requested circuit-switched service for a subscriber of wireless device 101. TIA PN-4287 (Wireless Intelligent Network Capabilities for Prepaid Charging) provides specifications for PPC processor 104 with respect to circuit-switched calls. In this configuration, PPC processor 104 functions as an accounting processor and is responsible for updating the subscriber's prepaid account for both voice services and data services.

PPC processor 104 can be implemented on different platforms, such as a service node (SN) or a service control point (SCP) in a wireless intelligent network. MSC 103 communicates with PPC processor 104 over interface 113. Interface 113 supports appropriate messages based upon Transaction Capabilities Application Part (TCAP) messaging in accordance with TIA PN-4287. MSC 103 notifies PPC processor 104 whenever the subscriber is requesting a prepaid circuit-switched call. PPC processor 104 verifies that the subscriber has an adequate balance and returns the corresponding notification to MSC 103 in order to proceed with the call. During the circuit-switched call, PPC processor activates a timer according to the remaining time in the subscriber's account. If the time expires, PPC processor 104 notifies MSC 103, instructing MSC 103 to end the call. When the circuit switched call is released, MSC 103 notifies PPC processor 104. PPC consequently stops its timer and updates the subscriber's account. The architecture of wireless communications system 100 can accommodate handover events in which wireless device 101 moves into a service area of another radio network or another MSC by incorporating a plurality of radio networks and a plurality of MSC's.

FIG. 2 illustrates an architecture for wireless communications system 200 for supporting prepaid billing for a packet-switched call according to U.S. patent application Ser. No. 09/773,039 entitled “Apparatus and Method for Prepaid Charging of Wireless Packet Data Services” filed on Jan. 30, 2001. In FIG. 2, wireless device 201 is communicating with radio network 203 over radio link 210. Radio network 203 transports packets of information that are either transmitted to or received from wireless device 201 over interface 204 to wireless packet service node-prepaid node (WPSN-PPN) 202. WPSN-PPN 202 completes the network connection to packet-switched network 206 through interface 207.

WPSN-PPN 202 determines a usage that is associated with the packet-switched call. Disclosed in this patent application are a plurality of metrics for measuring the usage, comprising a time of the packet-switched call, a number of transported packets, and a number of transported information octets. At the initiation of the packet-switched call, WPSN-PPN 202 is notified of a maximum usage that the subscriber can expend during the packet-switched call. If the maximum usage is exceeded, WPSN-PPN 202 notifies accounting processor 205 through interface 208, and the packet-switched call is ended. If this is not the case and the call is released by wireless device 201 or the destination of the packet-switched call, WPSN-PPN 202 reports the usage associated with the packet-switched call to accounting processor 205 through interface 208. Accounting processor 205 then adjusts the subscriber's prepaid account. The architecture of wireless communications system 200 can accommodate handover events in which wireless device 201 moves into a service area of another radio network or another MSC by incorporating a plurality of radio networks and a plurality of MSC's.

The application of the prepaid charging is important to the problem of measuring usage for packet-switched services and for circuit-switched services. With the integration of these services, a convergent prepaid billing solution facilitates the support of the integration of these services.

### SUMMARY OF THE INVENTION

The present invention enables a wireless communications system to support prepaid charging for a packet-switched call and a circuit-switched call that are associated with a subscriber and that coexist. The present invention utilizes an integrated accounting processor that fetches an amount remaining in the subscriber's prepaid account and determines a balance that the subscriber may use. An integrated prepaid node (IPPN) that is logically associated with an integrated wireless packet services node (IWPSN) monitors the usage associated with the packet-switched call and the circuit-switched call. When the packet-switched call ends, the IPPN reports the usage consumed during the packet-switched call and the circuit-switched call to the integrated accounting processor. The integrated accounting processor adjusts the subscriber's prepaid account in accordance with the usage. If the usage exceeds the balance during the calls, the IWPSN initiates the termination of the calls, and the IPPN notifies the integrated accounting processor.

A single unit (IPPN) monitors the usage of the coexistent calls. Prior art supports monitoring the usage of the packet-switched call at a prepaid packet node and the usage of the circuit-switched call at a prepaid charging processor. The need for a plurality of monitoring units may require messaging between the monitoring units in order to coordinate the monitoring of coexistent calls that are associated with the subscriber.

The present invention discloses exemplary embodiments in which either the radio network of the wireless device cannot simultaneously support a packet-switched call and a circuit-switched call because of a radio limitation. In such cases, the exemplary embodiment incorporates preemptive actions to terminate either the packet-switched call or the circuit-switched call. If the radio limitation does not apply to the radio network and the wireless device, the exemplary embodiment supports prepaid charging of the coexistent calls.

### BRIEF DESCRIPTION OF THE DRAWINGS

FIG. 1 illustrates an architecture of a wireless communications system supporting prepaid charging for a circuit-switched call according to prior art;

FIG. 2 illustrates an architecture of a wireless communications system supporting prepaid charging for a packet-switched call according to a co-pending patent application;

FIG. 3 illustrates an architecture for a wireless communications system supporting prepaid billing for a circuit-switched call and a packet-switched call that coexist;

FIG. 4 illustrates a flow diagram for initiating a circuit-switched call and a packet-switched call that coexist;

FIG. 5 illustrates a continuation of the flow diagram shown in FIG. 4;

FIG. 6 illustrates a flow diagram for maintaining a circuit-switched call and a packet-switched call subsequent to a call release;

FIG. 7 illustrates a message scenario for a circuit-switched call and a packet-switched call that coexist, in which the circuit-switched call is initiated after the packet-switched is initiated;

FIG. 8 illustrates a message scenario for a circuit-switched call and a packet-switched call that coexist, in which the packet-switched call is initiated after the circuit-switched call is initiated;

FIG. 9 illustrates a message scenario for initiating a circuit-switched call when a packet-switched call is in the dormant state, in which a radio network or a wireless device cannot simultaneously support the packet-switched call and the circuit-switched call;

FIG. 10 illustrates a message scenario for initiating an incoming circuit-switched call when a packet-switched call is in the active state, in which a radio network or a wireless device cannot simultaneously support the packet-switched call and the circuit-switched call;

FIG. 11 illustrates a message scenario for a handover of a packet-switched call that coexists with a circuit-switched call; and

FIG. 12 shows a data structure for determining a usage for a packet-switched call and a circuit-switched call that coexist for a subscriber.

### DETAILED DESCRIPTION

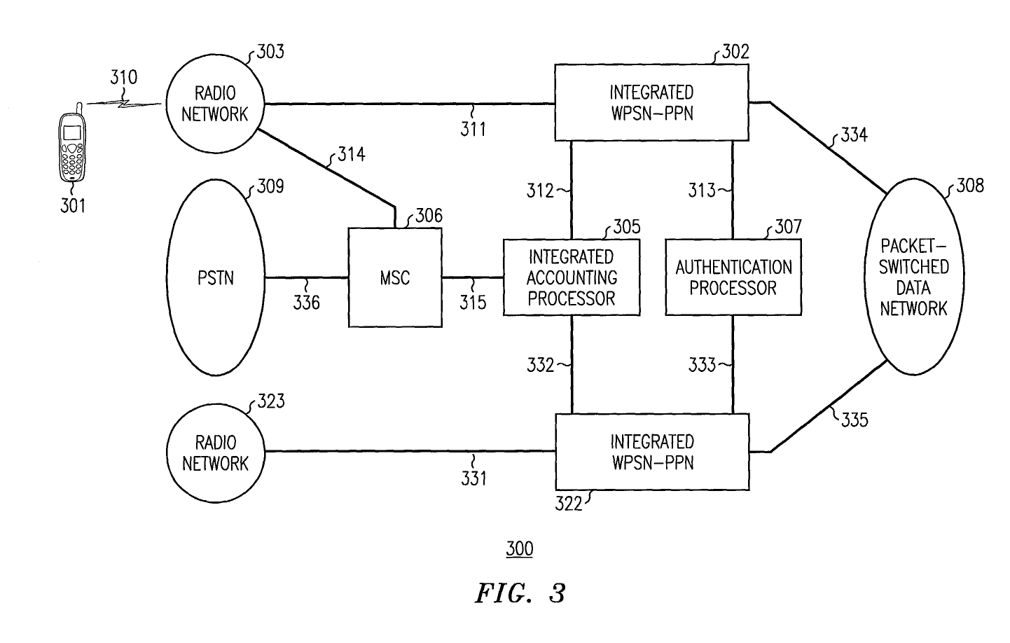

FIG. 3 illustrates an architecture of a wireless communications system 300 that supports prepaid charging of a packet-switched call and a circuit-switched call that are coexistent for a subscriber of wireless device 301. The packet-switched call and the circuit-switched call may have a relationship that offers an integrated service for the subscriber. Wireless device 301 may be a single physical platform or may correspond to a plurality of physical platforms that are logically associated in order to support both circuit-switched and packet-switched services to the subscriber.

In FIG. 3, a packet-switched call is established from wireless device 301 to radio network 303 over radio link 310. Wireless device 301 establishes a circuit-switched call to radio network 303 over radio link 310. (The circuit-switched call may transport data or voice services.) Radio network 303 routes the circuit-switched call to mobile switching center (MSC) 306 through interface 314. MSC 306 establishes a call path to public switching telephone network (PSTN) 309 over interface 336. MSC 306 can support a subsequent handover for the circuit-switched call. In the exemplary embodiment, MSC 306 is responsible for maintaining the circuit-switched call and may require supporting at least one handover during the call's duration.

Radio network 303 is connected to integrated wireless packet service node-prepaid node (integrated WPSN-PPN) 302 through interface 311. In the exemplary embodiment, interface 311 utilizes radio-packet (R-P) protocol, as is known in the art. Integrated WPSN-PPN 302 establishes a call path to packet-switched data network 308 through interface 334. In order to verify that wireless device 301 is valid, authentication processor 307 authenticates the subscriber utilizing methods and procedures through interface 313. If wireless device 301 moves from a service area corresponding to radio network 303, wireless device 301 is subsequently served by radio network 323, interface 331, integrated WPSN-PPN 322, and interface 335 to packet-switched data network 308.

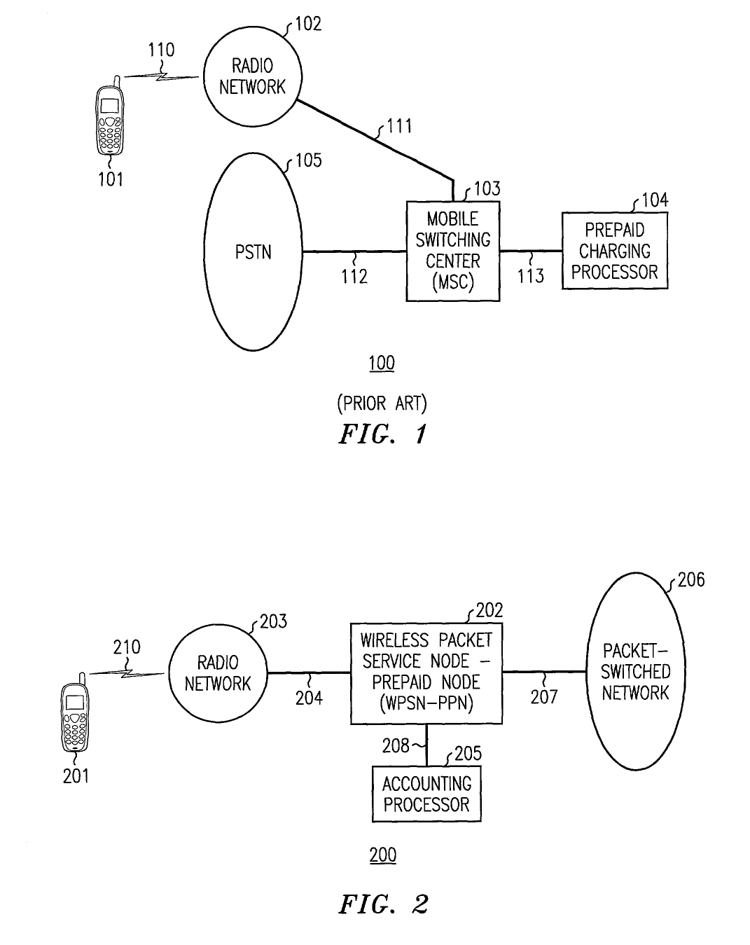

Integrated accounting processor 305 provides accounting functionality for both the circuit-switched call and the packet-switched call. MSC 306 notifies integrated accounting processor 305 through interface 315. In the exemplary embodiment, integrated accounting processor 305 is implemented by extending the functionality of PPC 104 (FIG. 1). Integrated accounting processor 305 maintains a usage associated with the subscriber for a circuit-switched call. When a packet-switched call is initiated, integrated accounting processor 305 determines a balance for wireless device 301 and provides integrated WPSN-PPN 302 a total limited usage (corresponding to a balance of the subscriber's prepaid account) through interface 312. The exemplary embodiment utilizes an application in which messages are transported over interface 312 and incorporates User Datagram Protocol (UDP) in conjunction with Internet protocol (IP). However, other protocol arrangements may be utilized such as Transport Control Protocol/Internet Protocol (TCP/IP) and Remote Authentication Dial In User Service (RADIUS). In the exemplary embodiment, the total limited usage indicates the active time duration of the circuit-switched call and a number of information octets transported between radio network 303 and wireless device 301. There are other metrics of usage including the number of transported packets.

Integrated WPSN-PPN 302 adjusts the balance of the subscriber until notified by integrated accounting processor 305 or until wireless device 301 releases the packet-switched call. If the circuit-switched call is ended, MSC 306 notifies integrated accounting processor 305 through interface 315. Integrated accounting processor 305 consequently notifies integrated WPSN-PPN 302 through interface 312 so that integrated WPSN-PPN 302 terminates a measurement of usage that is associated with the circuit-switched call.

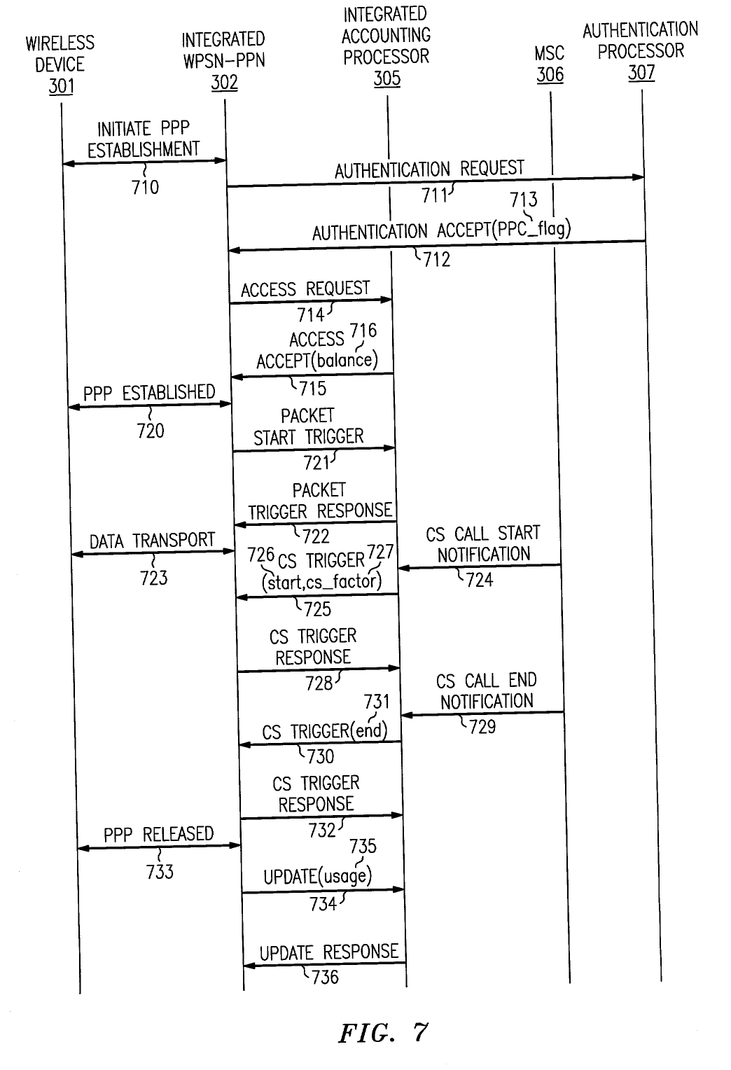

If the packet-switched call ends before the circuit-switched call, integrated WPSN-PPN 302 notifies integrated accounting processor 305 with the updated balance. The measurement of usage corresponding to the circuit-switched call is transferred to integrated accounting processor 305. (Message scenarios depicting various cases for prepaid charging of a packet-switched call and a circuit-switched call that are coexistent are discussed in conjunction with FIGS. 7, 8, 9, 10, and 11.)

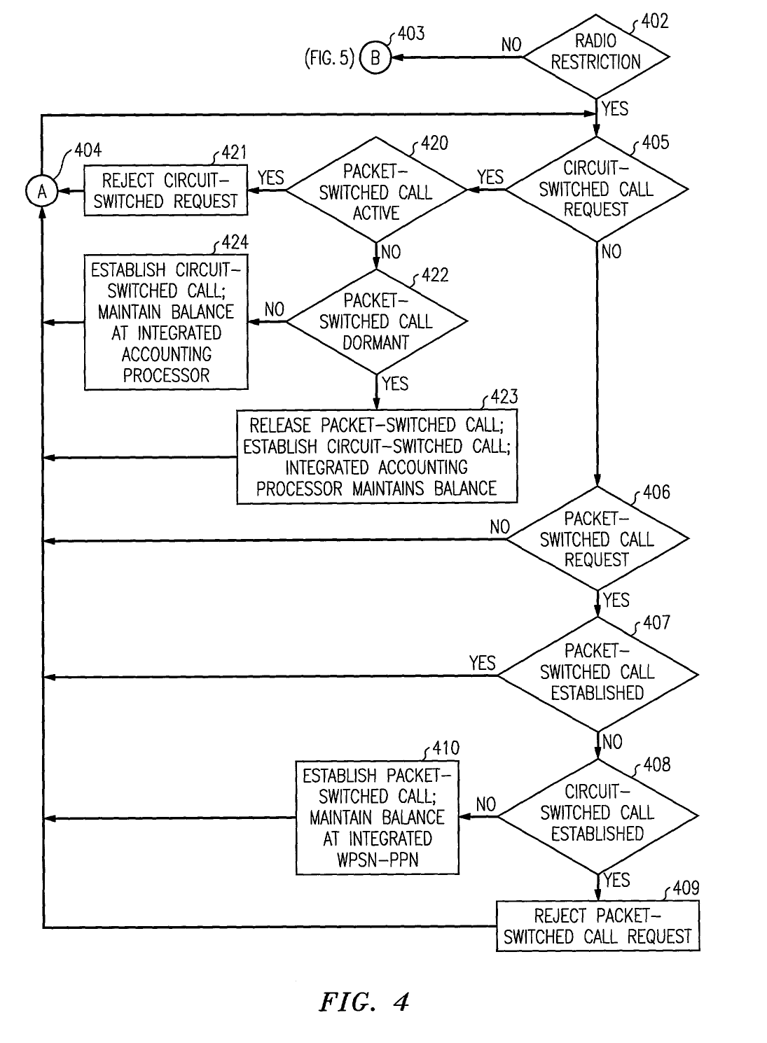

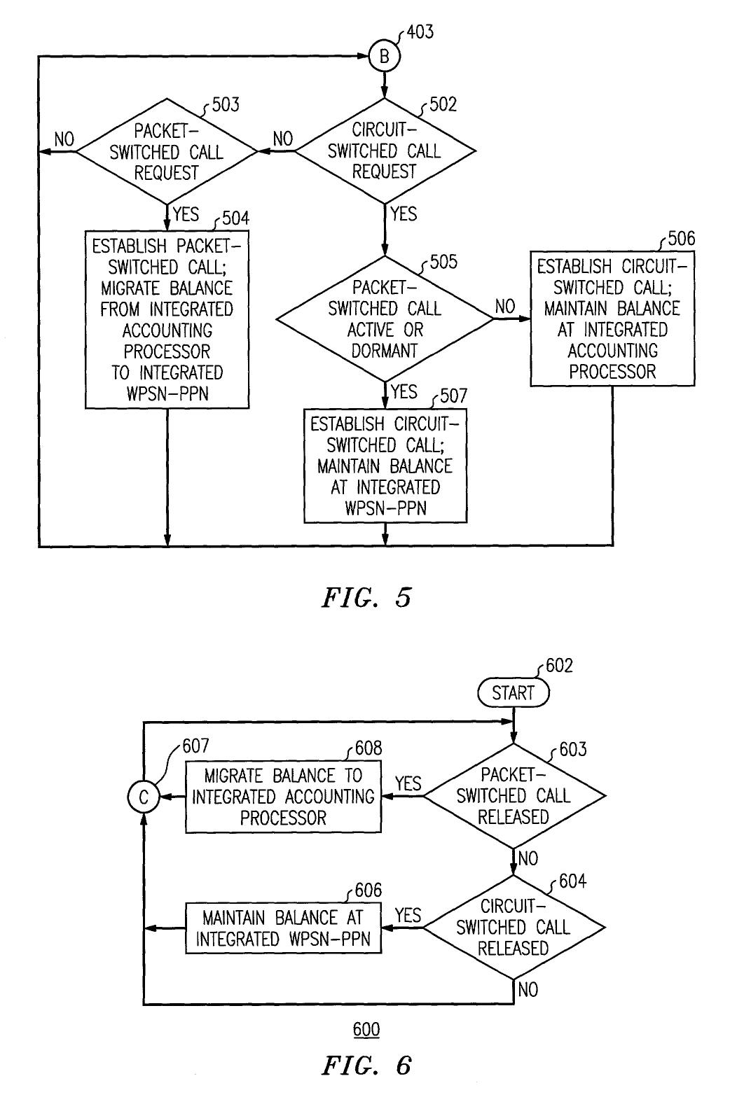

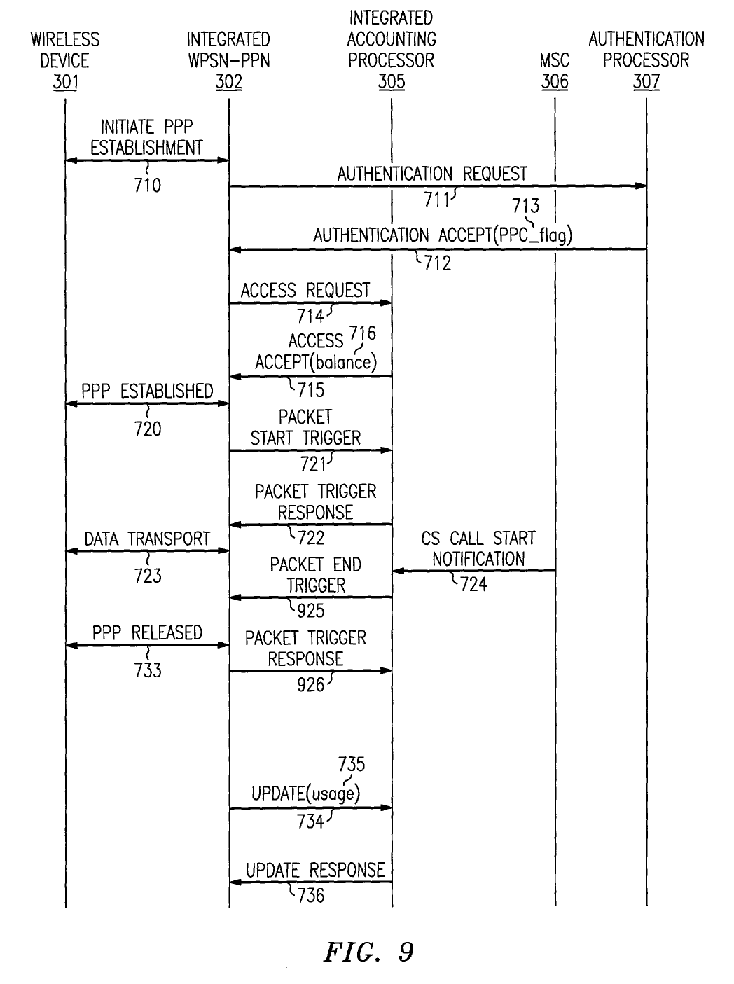

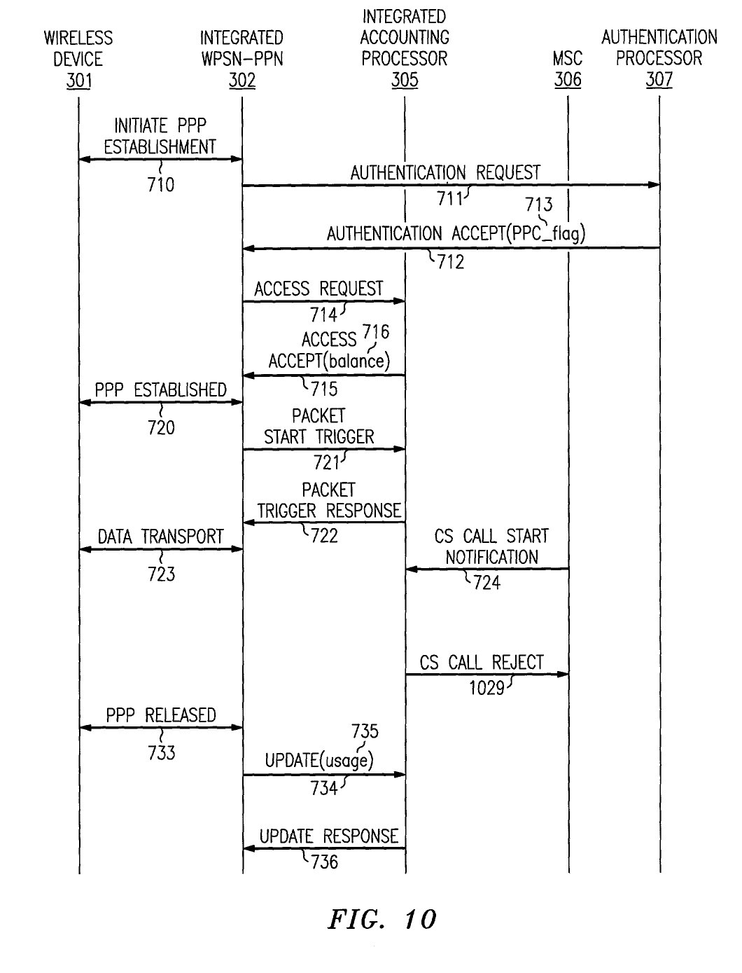

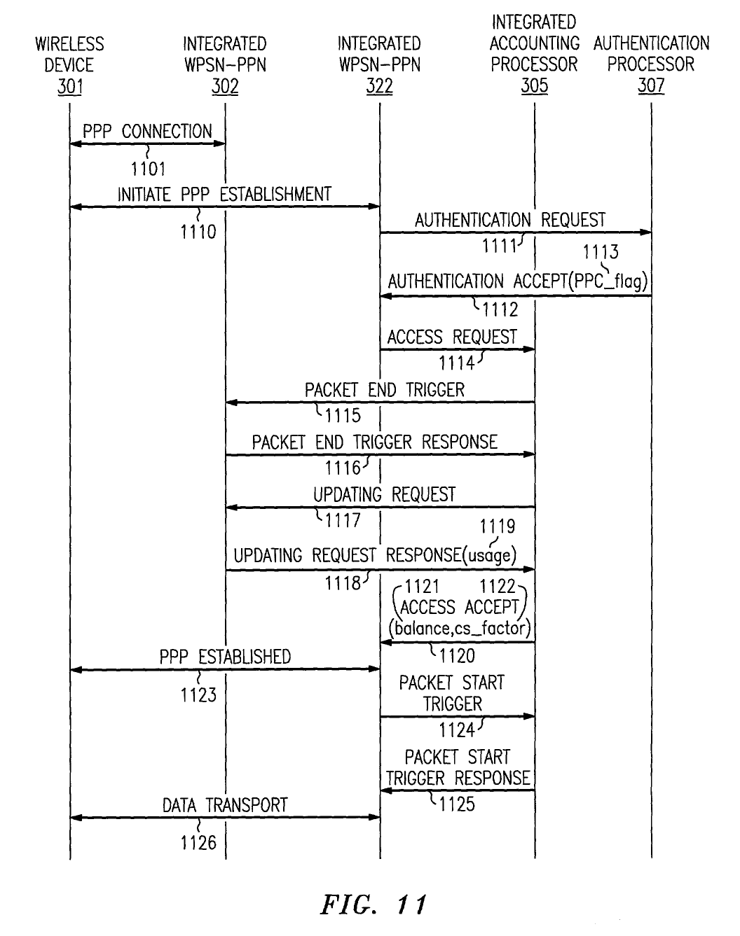

Wireless device 301 or radio network 303 may have radio limitations in which only a circuit-switched call or a packet-switched call can be supported at a given time. If this is the case, wireless communications system 300 utilizes logic shown in FIG. 4 and reflected in the message scenarios shown in FIGS. 9 and 10.

FIG. 4 illustrates a flow diagram for initiating a circuit-switched call and a packet-switched call that are coexistent. The call flow is exemplary and is modeled on the assumption that calls processing repetitively monitors whether a call initiation occurs. In step 402, call processing (which may reside at IWPSN-PPN 302 or integrated accounting processor 305) determines whether wireless device 301 or radio network 303 has a radio restriction in which only a circuit-switched call or a packet-switched call can be supported at a given time. If not, the call flow in FIG. 5 (discussed below) is utilized. If a radio restriction exists, step 405 is executed in order to determine if there is a circuit-switched call request. If so, call processing determines if a packet-switched call is active in step 420. If so, the circuit-switched call request is rejected in step 421, and the monitoring process is repeated in step 404. However, if step 420 determines that a packet-switched call is not active, step 422 determines if a packet-switched call is dormant. If not, the circuit-switched call is established and the balance of the subscriber's prepaid account is maintained by integrated accounting processor 305. If a packet-switched call is dormant as determined by step 422, the packet-switched call is ended. Integrated WPSN-PPN 302 notifies integrated accounting processor 305, and integrated accounting processor 305 subsequently maintains the balance during the circuit-switched call.

In step 405, if it is determined that a circuit-switched call request has not occurred, step 406 is executed to determine if there is a packet-switched call request. If not, no call request is pending, and the monitoring process is repeated in step 404. If a packet-switched call request occurs, step 407 is executed to determine if a packet-switched call is already established. If so, the packet-switched call request is rejected, and the monitoring process is repeated in step 404. If no packet-switched call currently is established, step 408 is executed to determine if a circuit-switched call currently is established. If so, the packet-switched call request is rejected in step 409, and the monitoring process is repeated in step 404. If a circuit-switched switched call is not currently established, as determined by step 408, the packet-switched call request causes integrated WPSN-PPN 302 to establish a packet-switched call and to maintain the balance.

FIG. 5 is a continuation of FIG. 4 in which neither wireless device 301 or radio network 303 has a radio restriction. In other words, both a packet-switched call and a circuit-switched call can be supported at the same time for the subscriber. In step 502, call processing determines if there is a circuit-switched call request. If not, step 503 is executed in order to determine if there is a packet-switched call request. If not, the monitoring process is repeated in step 403. If a packet-switched call request occurs, step 504 is executed in which the maintenance of the balance is migrated to integrated WPSN-PPN 302. If a circuit-switched call already exists, integrated WPSN-PPN 302 updates the balance for both the circuit-switched call and the packet-switched call. If step 502 determines that there is a circuit-switched call request, step 505 is executed to determine if a packet-switched call currently exists. If not, the balance is maintained at integrated accounting processor 305. The monitoring process is repeated in step 403. If a packet-switched call currently exists, as determined by step 505, the circuit-switched call is established by MSC 306, and integrated WPSN-PPN 302 maintains the balance for both the circuit-switched call and the packet-switched call.

FIG. 6 illustrates a flow diagram for maintaining a circuit-switched call and a packet-switched call that a coexistent subsequent to a call release. Step 602 initiates the process in which call processing initiates the maintenance of the coexistent calls. In the exemplary embodiment, the process is implemented at integrated WPSN-PPN 302. Process 600 periodically monitors the coexistent calls in order to determine if either the packet-switched call or the circuit-switched call is released.

With step 603, call processing determines if the packet-switched call is released. If so, step 608 is executed in which integrated WPSN-PPN 302 informs integrated accounting processor 305 of the updated balance, and integrated accounting processor 305 subsequently manages the balance of the circuit-switched call. If call processing does not detect that the packet-switched call is released in step 603, call processing determines if the circuit-switched call is released in step 604. If not, procedure 600 is repeated. If the circuit-switched call is released, integrated WPSN-PPN 302 maintains the balance of the packet-switched call and procedure 600 is repeated.

FIG. 7 illustrates a message scenario for a circuit-switched call and a packet-switched call that are coexistent in which the circuit-switched call is initiated after the packet-switched call is initiated. In order to initiate a packet-switched call for the subscriber, PPP establishment 710 is initiated between wireless device 301 and integrated WPSN-PPN 302. Consequently, integrated WPSN-PPN 302 verifies the validity of wireless device 301 by sending authentication request message 711 to authentication processor 307. Authentication processor 307 determines that the subscriber is a valid subscriber having a prepaid account and consequently sends authentication accept message 712 with PPC_flag 713 indicated. (PPC denotes prepaid charging and that the prepaid account is supported by integrated accounting processor 305.)

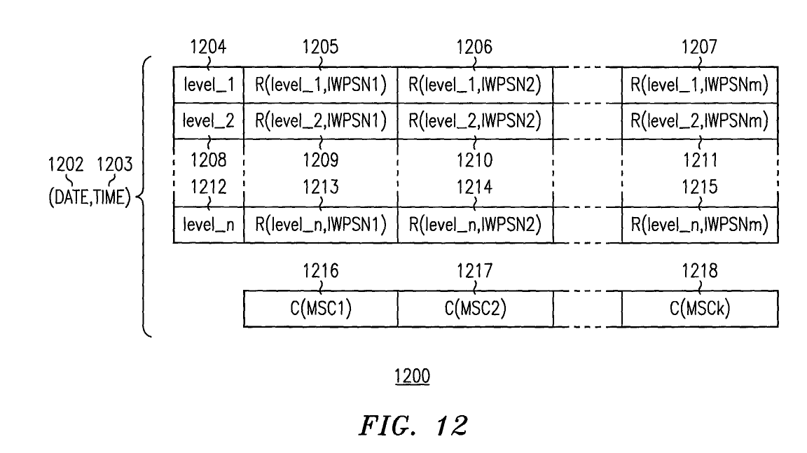

Integrated WPSN-PPN 302 queries integrated accounting processor 305 about the balance associated with the subscriber's prepaid account by sending access request message 714 to integrated accounting processor 305. Integrated accounting processor 305 determines the balance (which can be expressed in packets or information octets for example) and returns access accept message 715 with balance parameter 716 to integrated WPSN-PPN 302. The apparatus and methods for the determination and updating of the balance of a packet-switched call is disclosed in U.S. patent application Ser. No. 09/773,039 filed Jan. 30, 2001 and is incorporated by reference herein. In the exemplary embodiment, integrated accounting processor 305 utilizes the data structure shown in FIG. 12 to determine a charging rate (R in kilo-octets per dollar). The balance is calculated by multiplying the amount of the prepaid account by R.

Integrated WPSN-PPN 302 establishes PPP connection 720 between wireless device 301 and integrated WPSN-PPN 302. Integrated WPSN-PPN 302 notifies integrated accounting processor 305 that the PPP connection is established by sending packet start trigger message 721, and integrated accounting processor 305 responds with packet trigger response message 722. Data transport 723 commences between wireless device 301 and integrated WPSN-PPN 302. Integrated WPSN-PPN 302 monitors the amount of transported data in order to determine the associated usage of the packet-switched call.

During the time duration of the packet-switched call, wireless device 301 supports a circuit-switched call. With the initiation of the circuit-switched call, MSC 306 (which is supporting the circuit-switched call) notifies integrated accounting processor 305 with circuit-switched (CS) call start notification message 724. Integrated accounting processor 305 calculates a conversion factor that integrated WPSN-PPN 302 can utilize to determine the usage associated with circuit-switched call. In the exemplary embodiment, integrated accounting processor 305 utilizes the data structure shown in FIG. 12 to determine a charging rate (C in minutes per dollars) for the circuit-switched call and calculates the conversion factor by dividing R by C. In the exemplary embodiment, the usage associated with the circuit-switched call is determined by multiplying the conversion factor by the time duration of the circuit-switched call.

Integrated accounting processor 305 sends CS trigger message 725 informing integrated WPSN-PPN 302 about the circuit-switched call in order that WPSN-PPN 302 can measure the usage associated with both the packet-switched call and the circuit-switched call. Message 725 contains start_cs parameter 726 indicating that the circuit-switched call has commenced and CS_factor parameter 727 to provide the conversion factor. Integrated accounting processor 305 determines the total usage by monitoring the amount of transported data (e.g. number of kilo-octets) with the packet-switched call and by tracking the time duration of the circuit-switched call. Integrated accounting processor 305 determines the total usage by adding the usage associated with the packet-switched call with the usage associated with the circuit-switched call. (If the total usage exceeds the balance, as provided by balance parameter 716, integrated WPSN-PPN 302 terminates the packet-switched call and notifies integrated accounting processor 305. Integrated accounting processor 305 consequently instructs MSC 306 to terminate the circuit-switched call.) Integrated WPSN-PPN 302 returns CS trigger response message 728 to acknowledge message 725.

When the circuit-switched call ends, MSC 306 notifies integrated accounting processor 305 by sending CS call end notification message 729. Consequently, integrated accounting processor 305 sends CS trigger message 730 to integrated WPSN-PPN 302. End parameter 731 indicates that integrated WPSN-PPN 302 shall cease measuring the usage associated with the circuit-switched call. In other words, only the usage associated with the packet-switched call is measured until the packet-switched call is ended or a subsequent circuit-switched call is initiated during the time duration of the packet-switched call.

When the packet-switched call ends with PPP released 733, integrated WPSN-PPN 302 sends update message 734 with the usage associated with both the packet-switched call and the circuit-switched call as reflected by usage parameter 735. Integrated accounting processor 305 acknowledges messages 734 by returning update message 736 to integrated WPSN-PPN 302.

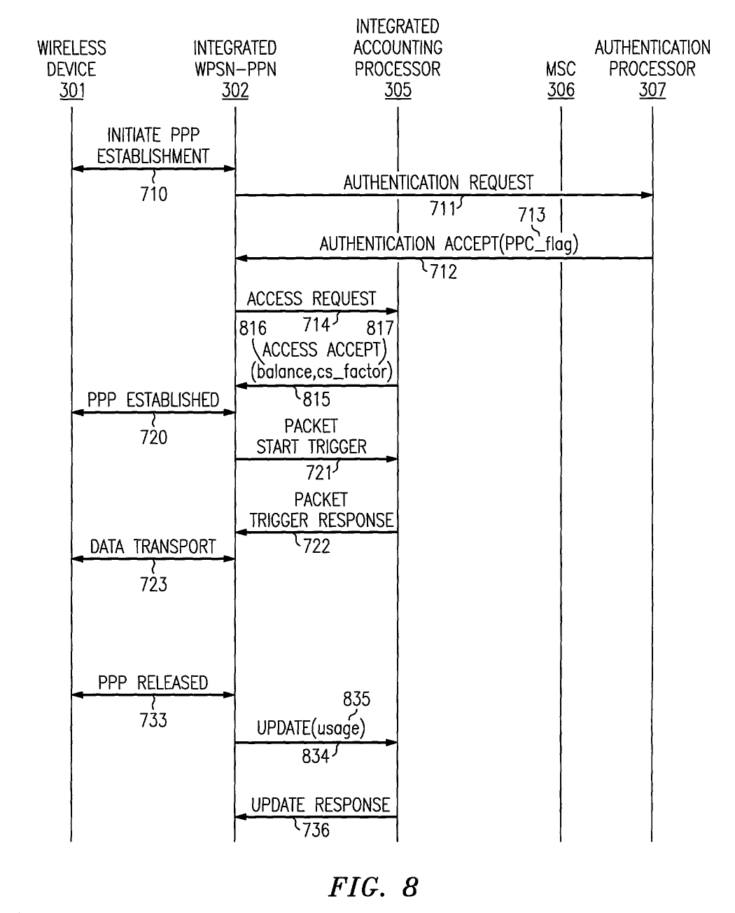

FIG. 8 illustrates a message scenario for a circuit-switched call and a packet-switched call that coexist in which the packet-switched call is initiated after the circuit-switched call is initiated. Messages 710, 711, 712, and 714 in FIG. 8 correspond to messages 710, 711, 712, and 714 in FIG. 7. In response to access request message 714, integrated accounting processor 305 determines the subscriber's balance. Because a circuit-switched call is already established, integrated accounting processor 305 determines a conversion factor in order that integrated WPSN-PPN 302 convert the time duration of the circuit-switched call into an associated usage that can be added to a usage associated with the packet-switched call. The sum is equated to the total usage that is consumed by the subscriber. Integrated accounting processor 305 sends access accept message 815 with balance parameter 816 and cs_factor 817 corresponding to the subscriber's balance and conversion factor, respectively.

Messages 720, 721, 722, 723, and 733 in FIG. 8 correspond to messages 720, 721, 722, 723, and 733 in FIG. 7. In FIG. 8, the packet-switched call is ended as denoted by PPP released 733. With this message scenario, the circuit-switched call is active at this time. Integrated WPSN-PPN 302 sends update message 834 with usage parameter 835 indicating the usage consumed by the subscriber. Integrated accounting processor 305 acknowledges message 834 by returning update response message 736 to integrated WPSN-PPN 302.

FIG. 9 illustrates a message scenario for initiating a circuit-switched call when a packet-switched call is in the dormant state, in which radio network 303 or wireless device 301 cannot simultaneously support the packet-switched call and the circuit-switched call. Messages 710, 711, 712, 714, 715, 720, 721, 722, 723, and 724 in FIG. 9 map to the corresponding messages in FIG. 7. MSC 306 notifies integrated accounting processor 305 that a circuit-switched call is being initiated for the subscriber. In FIG. 9, the packet-switched call is in the dormant state. In other words, no packet data is being transported between wireless device 301 and radio network 303. With the exemplary embodiment, the packet-switched call is ended if the packet-switched call is in the dormant state when the circuit-switched call is initiated. However, alternative embodiments may reject the circuit-switched call request and maintain the packet-switched call.

In order to end the packet-switched call, integrated accounting processor 305 sends packet end trigger message 925 to integrated WPSN-PPN 302. The packet-switched call is consequently released with PPP released 733, and integrated WPSN-PPN 302 returns packet trigger response message 926 to integrated accounting processor 305. Integrated WPSN-PPN 302 reports the usage consumed during the packet-switched call by sending update message 734 with update parameter 735. Integrated accounting processor 305 acknowledges message 734 by responding with message 736 and subsequently monitors the usage consumed during the circuit-switched call.

FIG. 10 illustrates a message scenario for initiating an incoming circuit-switched call to wireless device 301 when a packet-switched call is in the active state, in which radio network 303 or wireless device 301 cannot simultaneously support the packet-switched call and the circuit-switched call. Messages 710, 711, 712, 714, 715, 720, 721, 722, 723, and 724 in FIG. 10 map to the corresponding messages in FIG. 9. However, in FIG. 10 the packet-switched call is in the active state because packet data is being transported at the time that the incoming circuit-switched call is initiated. In the exemplary embodiment, the circuit-switched call is rejected. Integrated accounting processor 305 notifies MSC 306 to reject the circuit-switched call by sending CS call reject message 1029 to MSC 306. Messages 733, 734, and 736 in FIG. 10 map to the corresponding messages in FIG. 9.

FIG. 11 illustrates a message scenario for a handover of a packet-switched call that coexists with a circuit-switched call. Wireless device 301 has established a packet-switched call corresponding to PPP connection 1101. Radio network 303 determines that a handover is required in which the packet-switched call should be served by radio network 323. (With the exemplary embodiment, call processing of the circuit-switched call is controlled by MSC 306.)

Radio network 303 and 323 notify integrated WPSN-PPN 322 that wireless device 301 should be served by WPSN-PPN 322, and consequently integrated WPSN-PPN 322 initiates PPP establishment 1110 with wireless device 301. WPSN-PPN 322 authenticates wireless device 301 by sending authentication request message 1111 to authentication processor 307. Authentication processor 307 returns authentication accept message 1112 with PPC_flag parameter 1113, indicating that the subscriber has a valid prepaid account. Consequently, integrated WPSN-PPN 322 sends access request message 1114 to query integrated accounting processor 305 in order to obtain the subscriber's balance.

Integrated accounting processor 305 instructs integrated WPSN-PPN 302 to cease serving wireless device 301 for the packet-switched call by sending packet-end trigger message 1115, and integrated WPSN-PPN 302 responds by returning packet end trigger response message 1116. Integrated accounting processor 305 requests integrated WPSN-PPN 302 to inform integrated accounting processor 305 about the total usage consumed by the subscriber. Integrated WPSN-PPN 302 responds by returning updating request response message 1118 with usage parameter 1119. Integrated accounting processor 305 uses usage parameter 1119 to adjust the subscriber's prepaid account. Integrated accounting processor 305 sends access accept message 1120 to integrated WPSN-PPN 322, providing balance parameter 1121 (which indicates the updated subscriber's balance) and CS_factor parameter 1122 (which indicates the conversion factor for determining the usage associated with the circuit-switched call).

Integrated WPSN-PPN establishes PPP connection 1123 to commence the packet-switched call for wireless device 301 and informs integrated accounting processor 305 by sending packet start trigger message 1124. Integrated accounting processor 305 acknowledges message 1124 by returning packet start trigger response message 1125. Data transport 1126 commences between wireless device 301 and integrated WPSN-PPN 332. Integrated WPSN-PPN 322 assumes the monitoring of usage associated with the packet-switched call and the circuit-switched call.

FIG. 12 shows data structure 1200 for determining a usage for a packet-switched call and a circuit-switched call that coexist for a subscriber. An entry of data structure 1200 is identified by date 1202 and time of day 1203. In the exemplary embodiment, the rate of a packet-switched call R may vary by date 1202 (e.g. Friday) and by time 1203 (e.g. 8 a.m. to 6 p.m. corresponding to peak hours). Different levels of service are assigned to the subscriber, varying from the best level of service (level_1 1204) to the most economical level of service (level_n 1212). Intermediate levels of service, e.g. level_2 1208, are available. Moreover, the rate of the packet-switched call is dependent upon the IWPSN identification. Consequently, integrated accounting processor 305 determines the rate of the packet-switched call by appropriately selecting the rate (e.g. R 1205, R 1206, R 1207, R 1209, R 1210, R 1211, R 1213, R 1214, and R 1215). Integrated accounting processor 305 determines the balance by obtaining the amount in the subscriber's prepaid account and multiplying the amount by R.

Integrated accounting processor 305 determines the charging rate (C) associated with the circuit-switched call by date 1202, time of day 1203, and the MSC identification by selecting the appropriate charging rate (e.g. C 1216, C 1217, and C 1218) from data structure 1200. As discussed in FIG. 7, integrated accounting processor 305 calculates the conversion factor by dividing R by C. The conversion factor is used by IWPSN 302 to determine the usage associated with the circuit-switched call.

It is to be understood that the above-described embodiment is merely an illustrative principle of the invention and that many variations may be devised by those skilled in the art without departing from the scope of the invention. It is, therefore, intended that such variations be included with the scope of the claims.

What is claimed is:

1. A wireless communications system supporting simultaneous prepaid charging for a packet-switched call and a circuit-switched call, said calls associated with telecommunications services for a subscriber, said subscriber assigned a prepaid account, said wireless communications system communicating with a wireless device through a radio network, a radio communications path comprising said wireless device and said radio network, said wireless communications system comprising:
a first integrated prepaid packet node (IPPN);
a first integrated wireless packet serving node (IWPSN) logically associated with said first IPPN;
means for requesting said first IPPN through said first IWPSN for said packet-switched call in response to an initiation of said packet-switched call by said subscriber;
means for querying an integrated accounting processor by said first IPPN for a balance of said prepaid account in response to said means for requesting first IPPN for said packet-switched call, said balance indicating a total limited usage associated with said subscriber, said total limited usage comprising a first usage associated with said circuit-switched call and a second usage associated with said packet-switched call;
means for calculating said balance by said integrated accounting processor in response to said means for querying said integrated accounting processor; and
means for returning said balance to said first IPPN in response to said means for calculating said balance by said integrated accounting processor.

2. The wireless communications system of claim 1, further comprising:
means for authenticating said subscriber by an authentication processor in response to said means for requesting said first IPPN through said first IWPSN for said packet-switched call.

3. The wireless communications system of claim 1, wherein said balance exceeds a first minimum value, and further comprising:
means for completing a first packet-switched data connection to said wireless device by said first IWPSN in response to said means for returning said balance to said first IPPN by said integrated accounting processor.

4. The wireless communications system of claim 1, wherein said balance does not exceed a first minimum value, and further comprising:
means for rejecting said initiation of said packet-switched call by said first IWPSN in response to said means for returning said balance to said first IPPN by said integrated accounting processor.

5. The wireless communications system of claim 1, wherein an initiation of said circuit-switched call occurs after said initiation of said packet-switched call, further comprising:
means for updating said balance at said first IPPN by said integrated accounting processor.

6. The wireless communications system of claim 3, further comprising:
means for decrementing said balance by said first IPPN according to said first usage of said circuit-switched call and said second usage of said packet-switched call;
means for informing said first IWPSN by said first IPPN whenever said balance is less than said limited usage; and
means for discontinuing said packet-switched call and said circuit-switched call by said first IWPSN in response to said means for informing said first IWPSN by said first IPPN.

7. The wireless communications system of claim 1, wherein said means for calculating said balance by said integrated accounting processor comprises:
means for retrieving an amount in said prepaid account by said integrated accounting processor;
means for retrieving a first rate by said integrated accounting processor; said first rate associated with said circuit-switched call;
means for retrieving a second rate by said integrated accounting processor, said second rate associated with said packet-switched call; and
means for determining said balance from said first rate, said second rate, and said account.

8. The wireless communications system of claim 3, wherein an initiation of said circuit-switched call occurs after said initiation of said packet-switched call, wherein said radio communications path has a radio restriction, and wherein said packet-switched call is characterized by a dormant state, further comprising:
means for releasing said packet-switched call by said first IWPSN;
means for returning said balance by said first IPPN to said integrated accounting processor;
means for adjusting said balance by said integrated accounting processor in accordance with said first usage associated with said circuit-switched call.

9. The wireless communications system of claim 3, wherein an initiation of said circuit-switched call occurs after said initiation of said packet-switched call, wherein said radio communications path has a radio restriction, and wherein said packet-switched call is characterized by an active state, further comprising:
means for querying said integrated accounting processor by a mobile switching center (MSC) in response to said initiation of said circuit-switched call; and
means for rejecting said initiation of said circuit-switched call by said integrated accounting processor in response to said MSC querying said integrated accounting processor.

10. The wireless communications system of claim 1, wherein said initiation of said packet-switched call occurs after an initiation of said circuit-switched call, and wherein said radio communications path has a radio restriction, further comprising:
means for rejecting said initiation of said packet-switched call by said integrated accounting processor in response to said means for querying said integrated accounting processor by said first IPPN.

11. The wireless communications system of claim 3, further comprising:
means for instructing said first IPPN through said first IWPSN by said radio network that said packet-switched call is released by said wireless device in response to said subscriber discontinuing said packet-switched call;
means for updating said balance by said first IPPN in response to said means for instructing said first IPPN by said radio network;
means for sending said balance to said integrated accounting processor by said first IPPN in response to said means for updating said balance by said first IPPN; and
means for modifying said prepaid account by said integrated accounting processor in response to said means for sending said balance to said integrated accounting processor.

12. The wireless communications system of claim 3, further comprising:
means for instructing said first IPPN by said integrated accounting processor that said circuit-switched call is released by said wireless device in response to said subscriber discontinuing said circuit-switched call; and
means for updating said balance by said IPPN in response to said means for instructing said first IPPN by said integrated accounting processor.

13. The wireless communications system of claim 3, further comprising:
a second IPPN;
a second IWPSN logically associated with said second IPPN;
means for detecting a handover event associated with said packet-switched call by said second IPPN through said second IWPSN, said handover event generated by said radio network;
means for querying said integrated accounting processor by said second IPPN for said balance of said prepaid account in response to said means for detecting said handover event;
means for instructing said first IPPN by said integrated accounting processor to update said balance in response to said means for querying said integrated accounting processor by said second IPPN;
means for returning said balance to said integrated accounting processor by said first IPPN in response to said means for instructing said first IPPN by said integrated accounting processor;
means for responding with said balance by said integrated accounting processor to said second IPPN in response to said means for returning said balance to said integrated accounting processor by said first IPPN; and
means for completing a second data connection to said wireless device by said second IWPSN through said second IPPN in response to said means for responding with said balance by said integrated accounting processor to said second IPPN.

14. A memory for storing data for access by an applications program being executed on an integrated accounting processor, said applications program determining a total limited usage associated with a packet-switched call and a circuit-switched call, said calls associated with a subscriber, said packet-switched call served by an integrated wireless packet service node (IWPSN), said circuit-switched call served by a mobile switching center (MSC), said memory comprising:
a data structure stored in said memory, said data structure identified by a date and a time corresponding to said packet-switched call and said circuit-switched call, said data structure including information resident in a database used by said application program and including:
a level of service associated with said subscriber;
an identification of said IWPSN;
an identification of said MSC;
a first rate indicated by said identification of said MSC, said first rate associated with said circuit-switched call;
a second rate indicated by said identification of said IWPSN, said second rate associated with said packet-switched call.

15. An integrated accounting processor providing prepaid charging for a packet-switched call and a circuit-switched call in conjunction with a wireless system, said circuit-switched call and said packet-switched call associated with a subscriber, said wireless communications system comprising a first integrated prepaid packet node (IPPN) and a second IPPN, said accounting processor comprising:
means for calculating a balance by said integrated accounting processor in response to said first IPPN querying said integrated accounting processor; and
means for returning said balance to said first IPPN in response to said means for calculating said balance by said integrated accounting processor.

16. The integrated accounting processor of claim 15, wherein an initiation of said circuit-switched call occurs after an initiation of said packet-switched call, further comprising:
means for updating said balance at said first IPPN by said integrated accounting processor in response to said initiation of said circuit-switched call.

17. The integrated accounting processor of claim 15, wherein said means for calculating said balance comprises:
means for retrieving an amount in said prepaid account by said integrated accounting processor;
means for retrieving a first rate by said integrated accounting processor; said first rate associated with said circuit-switched call;
means for retrieving a second rate by said integrated accounting processor, said second rate associated with said packet-switched call; and
means for determining said balance from said first rate, said second rate, and said account.

18. The integrated accounting processor of claim 15, further comprising:
means for modifying a prepaid account of said subscriber in response to said first IPPN sending an updated balance to said integrated accounting processor.

19. The integrated accounting processor of claim 15, further comprising:
means for instructing said first IPPN by said integrated accounting processor to update said balance in response to said integrated accounting processor being notified of a handover event by said second IPPN; and
means for sending said balance to said second IPPN in response to receiving said balance from said first IPPN.

20. An integrated prepaid packet node (IPPN) supporting prepaid charging for a packet-switched call and a circuit-switched call in conjunction with a wireless system, said circuit-switched call and said packet-switched call associated with a subscriber, said wireless communications system comprising a wireless packet serving node (IWPSN), an integrated accounting processor, and said IPPN, said IPPN comprising:
means for querying said integrated accounting processor by said IPPN for a balance of a prepaid account of said subscriber in response to said IWPSN requesting said IPPN; and
means for updating said balance at said IPPN according to a usage associated with said packet-switched call and said circuit-switched call.

21. The IPPN of claim of 20, further comprising:
means for informing said IWPSN by said IPPN whenever said balance is less than a limited usage.

22. The IPPN of claim 20, further comprising:
means for sending said balance to said integrated accounting processor in response to said packet-switched call being released.

23. The IPPN of claim 20 further comprising:
means for sending said balance to said integrated accounting processor in response to said integrated accounting processor instructing said IPPN.

24. A method for a wireless communications system supporting prepaid charging for a packet-switched call and a circuit-switched call, said calls associated with telecommunications services for a subscriber, said subscriber assigned a prepaid account, said wireless communications system communicating with a wireless device through a radio network, a radio communications path comprising said wireless device and said radio network, said method comprising the steps of:
requesting said first integrated prepaid packet node (IPPN) through said first integrated wireless packet serving node (IWPSN) for said packet-switched call responsive to an initiation of said packet-switched call by said subscriber;
querying an integrated accounting processor by said first IPPN for a balance of said prepaid account responsive to said step of requesting first IPPN for said packet-switched call, said balance indicating a total limited usage associated with said subscriber, said total limited usage comprising a first usage associated with said circuit-switched call and a second usage associated with said packet-switched call;
calculating said balance by said integrated accounting processor responsive to said step of querying said integrated accounting processor; and
returning said balance to said IPPN responsive to said step of calculating said balance by said integrated accounting processor.

25. The method of claim 24, further comprising the step of:
authenticating said subscriber by an authentication processor responsive to said step of requesting said first IPPN through said first IWPSN for said packet-switched call.

26. The method of claim 24, wherein said balance exceeds a first minimum value, and further comprising the step of:
completing a first packet-switched data connection to said wireless device by said first IWPSN responsive to said step of returning said balance to said first IPPN by said integrated accounting processor.

27. The method of claim 24, wherein said balance does not exceed a first minimum value, and further comprising the step of:
rejecting said initiation of said packet-switched call by said first IWPSN responsive to said step of returning said balance to said first IPPN by said integrated accounting processor.

28. The method of claim 27, wherein an initiation of said circuit-switched call occurs after said initiation of said packet-switched call, further comprising the step of:
updating said balance at said first IPPN by said integrated accounting processor.

29. The method of claim 26, further comprising the steps of:
decrementing said balance by said first IPPN according to said first usage of said circuit-switched call and said second usage of said packet-switched call;
informing said first IWPSN by said first IPPN whenever said balance is less than said total limited usage; and
discontinuing said packet-switched call and said circuit-switched call by said first IWPSN responsive to said step of informing said first IWPSN by said first IPPN.

30. The method of claim 24, wherein said step of calculating said balance by said integrated accounting processor comprises:
retrieving an amount in said prepaid account by said integrated accounting processor;
retrieving a first rate by said integrated accounting processor; said first rate associated with said circuit-switched call;
retrieving a second rate by said integrated accounting processor, said second rate associated with said packet-switched call; and
determining said balance from said first rate, said second rate, and said account.

31. The method of claim 26, wherein an initiation of said circuit-switched call occurs after said initiation of said packet-switched call, wherein said radio communications path has a radio restriction, and wherein said packet-switched call is characterized by a dormant state, further comprising the steps of:
releasing said packet-switched call by said first IWPSN;
returning said balance by said first IPPN to said integrated accounting processor;
adjusting said balance by said integrated accounting processor in accordance with said first usage associated with said circuit-switched call.

32. The method of claim 26, wherein an initiation of said circuit-switched call occurs after said initiation of said packet-switched call, wherein said radio communications path has a radio restriction, and wherein said packet-switched call is characterized by an active state, further comprising the steps of:
querying said integrated accounting processor by a mobile switching center (MSC) in response to said initiation of said circuit-switched call; and
rejecting said initiation of said circuit-switched call by said integrated accounting processor responsive to said step of querying said integrated accounting processor by said MSC.

33. The method of claim 24, wherein said initiation of said packet-switched call occurs after an initiation of said circuit-switched call, and wherein said radio communications path has a radio restriction, further comprising the step of:
rejecting said initiation of said packet-switched call by said integrated accounting processor responsive to said step of querying said integrated accounting processor by said first IPPN.

34. The method of claim 26, further comprising the steps of:
instructing said first IPPN through said first IWPSN by said radio network that said packet-switched call is released by said wireless device responsive to said subscriber discontinuing said packet-switched call;
updating said balance by said first IPPN responsive to said step of instructing said first IPPN by said radio network;
sending said balance to said integrated accounting processor by said first IPPN responsive to said step of updating said balance by said first IPPN; and
modifying said prepaid account by said integrated accounting processor responsive to said step of sending said balance to said integrated accounting processor.

35. The method of claim 26, further comprising the steps of:
instructing said first IPPN by said integrated accounting processor that said circuit-switched call is released by said wireless device responsive to said subscriber discontinuing said circuit-switched call; and
updating said balance by said first IPPN responsive to said step of instructing said first IPPN by said integrated accounting processor.

36. The method of claim 26, further comprising the steps of:
a second IPPN;
a second IWPSN logically associated with said second IPPN;
detecting a handover event associated with said packet-switched call by a second IPPN through a second IWPSN, said handover event generated by said radio network;
querying said integrated accounting processor by said second IPPN for said balance of said prepaid account responsive to said step of detecting said handover event;
instructing said first IPPN by said integrated accounting processor to update said balance responsive to said step of querying said integrated accounting processor by said second IPPN;
returning said balance to said integrated accounting processor by said first IPPN responsive to said step of instructing said first IPPN by said integrated accounting processor;
responding with said balance by said integrated accounting processor to said second IPPN responsive to said step of returning said balance to said integrated accounting processor by said first IPPN; and
completing a second data connection to said wireless device by said second IWPSN through said second IPPN responsive to said step of responding with said balance by said integrated accounting processor to said second IPPN.

37. A method for supporting prepaid charging with an integrated accounting processor for a packet-switched call and a circuit-switched call in conjunction with a wireless system, said circuit-switched call and said packet-switched call associated with a subscriber, said wireless communications system comprising a first integrated prepaid packet node (IPPN) and a second IPPN, said method comprising the steps of:
calculating a balance by said integrated accounting processor responsive to said first IPPN querying said integrated accounting processor; and
returning said balance to said first IPPN responsive to said step of calculating said balance by said integrated accounting processor.

38. The method of claim 37, wherein an initiation of said circuit-switched call occurs after an initiation of said packet-switched call, further comprising the step of:
updating said balance at said first IPPN by said integrated accounting processor.

39. The method of claim 37, wherein said step of calculating said balance comprises:
retrieving an amount in said prepaid account by said integrated accounting processor;
retrieving a first rate by said integrated accounting processor; said first rate associated with said circuit-switched call;
retrieving a second rate by said integrated accounting processor, said second rate associated with said packet-switched call; and
determining said balance from said first rate, said second rate, and said account.

40. The method of claim 37, further comprising the step of:
modifying a prepaid account of said subscriber responsive to said first PPN sending an updated balance to said integrated accounting processor.

41. The method of claim 37, further comprising the steps of:
instructing said first IPPN by said integrated accounting processor to update said balance responsive to said integrated accounting processor being notified of a handover event by said second IPPN; and
sending said balance to said second IPPN responsive to receiving said balance from said first IPPN.

42. A method for supporting prepaid charging with an integrated prepaid packet node (IPPN) for a packet-switched call and a circuit-switched call in conjunction with a wireless system, said circuit-switched call and said packet-switched call associated with a subscriber, said wireless communications system comprising a wireless packet serving node (IWPSN), an integrated accounting processor, and said IPPN, said IPPN comprising:
querying said integrated accounting processor by said IPPN for a balance of a prepaid account of said subscriber responsive to said IWPSN requesting said IPPN; and
updating said balance at said IPPN according to a usage associated with said packet-switched call and said circuit-switched call.

43. The method of claim of 42, further comprising:
informing said IWPSN by said IPPN whenever said balance is less than a limited usage.

44. The method of claim 42, further comprising:
sending said balance to said integrated accounting processor responsive to said packet-switched call being released.

45. The method of claim 42, further comprising:
sending said balance to said integrated accounting processor responsive to said integrated accounting processor instructing said IPPN.
